(19) United States
(12) Patent Application Publication
(10) Pub. No.: US 2010/0322721 A1
(43) Pub. Date: Dec. 23, 2010

(54) METHOD AND APPARATUS FOR RECEIVING FINE-GRAINED TO COARSE-GRAINED SOLIDS FROM A VESSEL AND TRANSFERRING THEM TO A HIGHER-PRESSURE SYSTEM

(75) Inventors: Stefan Hamel, Wenden (DE); Johannes Kowoll, Bochum (DE); Eberhard Kuske, Soest (DE)

Correspondence Address: COLLARD & ROE, P.C., 1077 NORTHERN BOULEVARD, ROSLYN, NY, 11576, US

(73) Assignee: UHDE GMBH

(21) Appl. No.: 12/735,681

(22) PCT Filed: Jan. 23, 2009
(86) PCT No.: PCT/EP2009/000403

§ 371 Date: Aug. 6, 2010

(30) Foreign Application Priority Data
Feb. 9, 2008 (DE) 10 2008 008 419.0

(51) Int. Cl. B65G 53/22

(52) U.S. Cl. 406/146

(57) ABSTRACT

A device and a method for receiving and handing over fine-grain to coarse-grain solids from a container to a higher pressure system via a cut-off device. The device and method allow improvement of the hand-over of the solids while reliably guaranteeing the solids transport even for difficult bulk materials, high operational flexibility when used for various bulk materials and high flow rates towards the receiving container while avoiding compression of the bulk material. The device is formed from at least one vertical central tubular body (central tube) which is arranged inside the container at a distance in the direction of gravitation upstream of the cut-off device and which is open at the top and at the bottom, and by gas supply devices impinging the container bottom and/or the central tube to produce a solids flow in the central tube.

The invention relates to an apparatus and a method for receiving fine-grained to coarse-grained solids from a vessel and transferring them to a higher-pressure system by way of a shutoff mechanism, whereby the vessel is equipped with devices for supplying the solid and for supplying gases to raise the pressure in the vessel, as well as with devices for pressure equalization during filling and emptying, whereby the vessel bottom is formed as a funnel for supplying the shutoff mechanism.

Numerous practical cases exist in which it is necessary to supply a system with fuels, for example from the surroundings, which fuels will be processed at a pressure much higher than the ambient pressure in the further course of the process.

Such a situation occurs, for example, during thermal conversion of solid fuels, such as different coals and also peat, hydrogenation residues, residual substances, wastes, biomasses, fly ash or the like, where these terms are also to be understood as all mixtures of such substances. Examples of conversion processes of this type include high-pressure incineration, high-pressure gasification, fluidized-bed processes and carrier-gas processes.

In such processes, for example in high-pressure gasification of coal dust, pressures up to 45 bar are not unusual, and so the substances to be converted would have to be brought up to this pressure before gasification, whereby higher pressures also lead to greater system capacities.

Greater system capacities mean larger amounts of fuels to be transported, whereby vice versa, larger amounts of ash or slag have to be managed at the same time. In this connection, it must be kept in mind that geometric limits are imposed on such sluices or sluice vessels by the behavior to be expected of the bulk material or by discharge mechanisms, connecting lines, fittings or the available localities. In this connection, an increase can be achieved, for example, in that the number of vessels and/or the throughput during the sluicing operation is increased.

Several solutions addressing this problem already exist; for example, WO 2004/085578 A1 discloses a sluice vessel provided internally in the conical vessel part with gas-supplying elements, by way of which the vessel is brought up to the target pressure. DE 41 08 048 discloses similar elements in the conical part of the pressure dome, for the purpose of achieving fluidization of the solid bulk material in order to improve pneumatic conveyance out of the pressure dome. In WO 98/11378 it is proposed that gas be supplied by installing porous elements in the outlet cone of the silo in order to permit a more uniform flow of material. A similar feature is described in U.S. Pat. No. 4,941,779.

Apparatuses inside vessels for the purpose of simplifying the discharge of powdered material are also known, for example, from DE 11 30 368 A, DE 195 21 766 A, GB 940 506 A or U.S. Pat. No. 2,245,664 A, whereby the auxiliary means are used exclusively to supply fluidizing air.

It is also known that discharges of bulk goods from vessels can be achieved by way of worm conveyors or similar elements.

The object of the invention is to provide an apparatus for discharging solids, which apparatus can be pressurized with selective priming of the vessel, while avoiding compression of the bulk material and safely assuring transportation of the solids even in the case of difficult bulk material, along with great flexibility in the use of different bulk materials during operation and the highest possible mass flow toward the receiving vessel.

With an apparatus of the type mentioned above, this object is achieved, according to the invention, in that at least one vertically aligned central tubular member (central tube) open at the top and bottom as well as gas-supply devices for admitting gas to the vessel bottom and/or the central tube in order to generate a flow of solids in the central tube is provided inside the vessel above the shutoff mechanism in the direction of gravity and spaced apart from it.

It has been shown that the provision of a central tube in combination with gas-supply devices leads to very good conditions for transfer of the solid from the sluice vessel into a downstream pressure vessel. Among other advantages, this leads to the achievement of very short cycle times.

Further embodiments of the invention are specified in the dependent claims, whereby it may be provided that the central tube is of double-wall construction and has gas applied to it by at least one gas-supply line, whereby the tube wall is provided with gas-outlet apertures.

The possibility of supplying gas both by way of the walls of the central tube and by way of the vessel walls, especially the vessel bottom, leads to several advantages, both in the phase of filling of the vessel with material to be transferred and in the discharge phase, when the material is being transferred under higher pressure.

An important embodiment of the invention consists in that the central tube is equipped with inlet apertures, distributed over its length, for the solid, thereby making it possible for the solid to flow into the interior of the tube. In the process, because the central tube is equipped with outwardly directed and/or inwardly directed gas-outlet apertures, as is also provided by the invention, targeted flow behavior of the solid in the interior of the vessel can be achieved, in accordance with the wishes of the operator.

A further practical embodiment of the invention consists in that annular chambers are formed by partition walls in the double-walled central tube, whereby each annular chamber is equipped with at least one gas-supply line, the solid-inlet apertures into the interior of the central tube are provided between the annular chambers, and the diameter of the annular chambers may be the same or different. By the fact that the individual annular chambers are provided with individual gas supplies, it is possible, for example, to improve the incoming flow of solid from outside to inside through the corresponding inlet aperture for solids, by way of the end faces of an annular chamber disposed at a higher level.

In this way, it is also possible to provide annular chambers of progressively smaller diameter in the manner of a cascade in the direction of gravity from top to bottom, or to construct an alternation of annular chambers with small and large diameter, or to form the annular chambers themselves as funnels, for example with the smaller diameter disposed lower in the direction of gravity.

The invention also provides a multiple distribution of gas-outlet apertures, for example in the vessel walls, the central-tube walls, the connecting nozzles assigned to the sluice and other similar locations, whereby in particular, it may also be provided that the outlet apertures are equipped with appropriate elements for guiding the gas flow, in order to form predefined flows, such as tangential flows.

It may also be provided that a protective/deflecting hood is disposed above the tube in order to deflect the upwardly directed flow of solids during priming of the vessel and to prevent the tube from filling with solid during the filling operation.

With a method of the type mentioned in the introduction, the object of the invention defined above is achieved in that at least one vertically aligned central tubular member (central tube) is provided inside the vessel above the shutoff mechanism in the direction of gravity, at a distance from it, whereby the filling of the receiving vessel, which initially is under ambient pressure, with solid takes place in the annular space formed between the inside wall of the vessel and the outside wall of the central tube, and a gas is injected in the region of the shutoff mechanism during the filling operation, whereby pressure equalization in the vessel is achieved by way of a gas supply/removal controller, and subsequently the vessel is brought up to the higher system pressure prevailing on the other side of the shutoff mechanism by means of supplying gas, whereby the gas is injected in such a way that an upwardly directed flow of solid is formed at first in the central tube.

Further embodiments of the invention are specified in the further dependent claims relating to the method.

Examples of the invention will be explained below, on the basis of the drawing. This shows, in

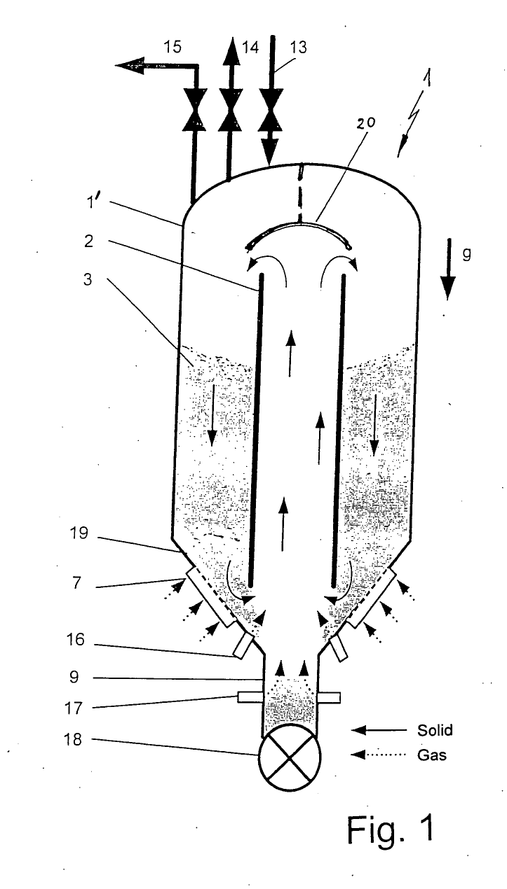

FIG. 1 a schematic diagram of a sluice vessel according to the invention,

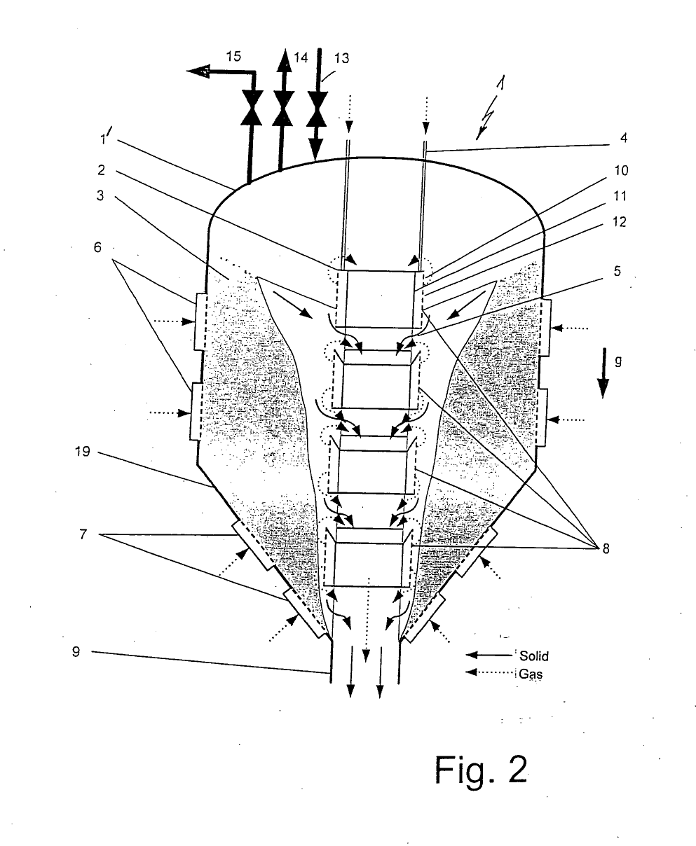

FIG. 2 in a similar representation, a schematic section through a sluice vessel according to the invention, with central tube,

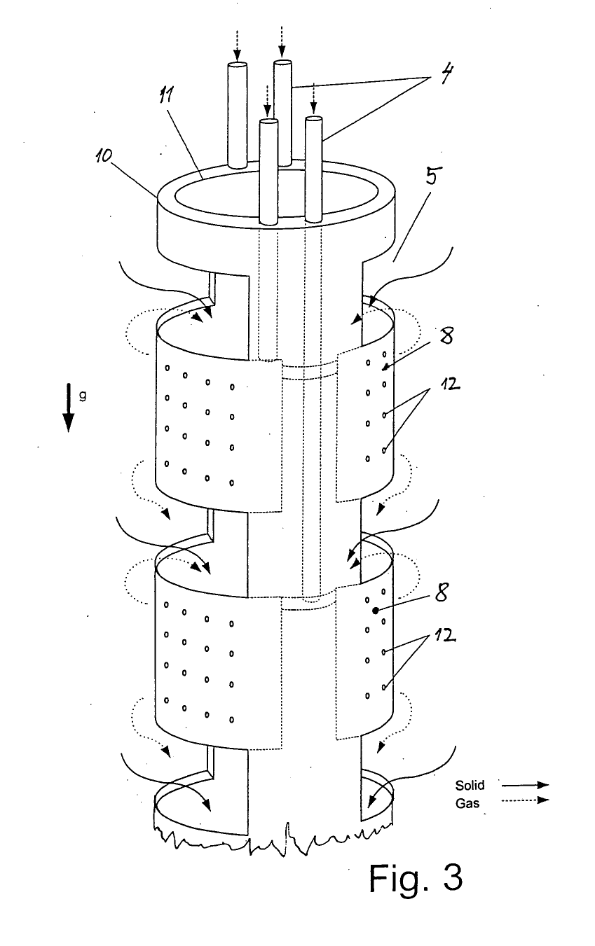

FIG. 3 a slightly enlarged detail drawing of part of the central tube, and

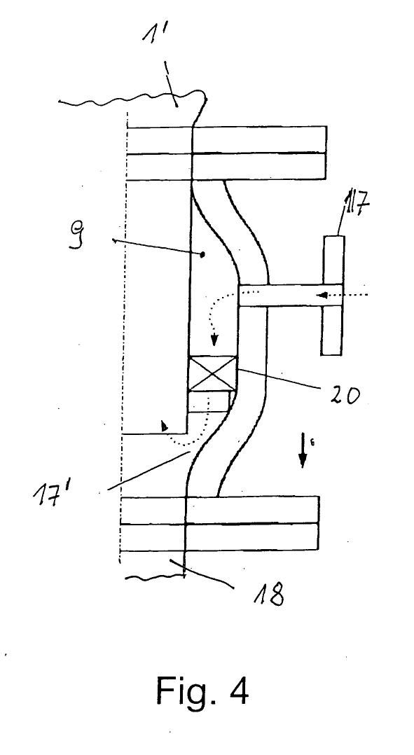

FIG. 4 an enlarged schematic detail section of the gas supply in the nozzle connected to the shutoff mechanism.

The apparatus denoted as a whole by 1 is illustrated substantially schematically in FIG. 1. This apparatus 1 consists substantially of a sluice vessel 1′, in the interior of which a tube—referred to hereinafter as central tube 2—is provided. This vessel 1′ is provided with a bed 3 of solids, whereby the arrows in FIG. 1 illustrate a flow pattern that develops during priming, or in other words pressurization, of the vessel by means of compressed air.

In FIGS. 1 and 2, the flows of solid are indicated with solid arrows, while the dotted arrows represent the gas flow. Another downwardly pointing arrow indicating the direction of gravity “g” is shown on the right side of the figures.

In the example of FIG. 1, gas-supply units 7 are provided in the vessel bottom, which is denoted by 19, and gas supplies 16 are provided in the transition region to the outlet nozzle 9, which region leads to a shutoff mechanism 18, whereby additional gas supplies 17 are provided at the outlet nozzle 9 for the purpose of generating gas flows, which are capable, during filling of the vessel, for example, of generating a flow of solids that is offset from the center of the central tube 2 and is directed upward in the central tube 2, as indicated by arrows in FIG. 1. In order to prevent penetration of solid from above into the central tube during the filling operation, a deflecting or protective hood can be provided above the central tube, as is schematically illustrated and denoted by 20 in FIG. 1. The gas supply in the tube nozzle 9 is illustrated in more detail in FIG. 4.

Reference numerals 14 and 15 denote equalizing-gas lines, by way of which, for example, the air present in the vessel can escape during filling, thus allowing the pressure in the vessel to remain constant during this operation.

In the illustrative example of FIG. 2, the central tube 2 is shown in simplified form as a double-walled tube having a tube composed of segments, wherein the individual tube segments, denoted by 8, are spaced apart from one another, in each instance, in such a way that inlet apertures 5 are formed for the solid or for an appropriately guided carrier gas during emptying of the vessel. This emptying situation is depicted in FIG. 2, whereby the stream of solids is again indicated by solid small arrows while the gas flow is represented by dotted arrows.

The tube segments 8 together with their inner tube jacket 11 have gas-outlet apertures, which are denoted by 12, on their outer tube jacket 10.

In the example of FIG. 2, gas-supply units 7 are provided only in the funnel region of the vessel 1′, but also in the cylindrical peripheral region. These gas-supply units are denoted by 6 in FIG. 2.

By way of supply lines 4, gas can be admitted to the annular spaces of central tube 2 between outer tube jacket 10 and inner tube jacket 11, whereby a common gas supply can be provided (FIG. 2) or also, individual gas supplies can be provided for each tube segment, as indicated in FIG. 3.

The principle of operation of the apparatus according to the invention and of the method of procedure according to the invention is the following:

By way of the solid supply 13, the vessel 1′ is first filled with solid in such a way that the central tube, which is disposed above the shutoff mechanism 18, in relation to the funnel-shaped bottom of the vessel, is not filled, whereby a certain proportion of solids piles up above the shutoff mechanism. This situation is illustrated in FIG. 1.

If the vessel is now primed, gas is simultaneously supplied under individual control by way of the segments 8 of the central tube 2 and by way of the gas-supply units 6 and 7 disposed on the vessel wall and/or on the vessel bottom, as well as by way of the gas supplies 16 and 17, in such a way that the ascending flow of solids illustrated in FIG. 1 is developed in the interior of the central tube, whereby care is also taken to ensure that the region immediately upstream from the shutoff mechanism 18 is fluidized or stirred up by way of the gas-supply lines 17. For this purpose, the advantageous mode of operation is such that the main gas supply takes place by way of this gas supply 17 in the outlet. This results in forced circulation of solids inside the vessel, thus preventing compacting of the material that would occur in bulk material at rest.

In FIG. 4 it is indicated that the gas supply 17 can be configured in such a way that a swirling flow into the connecting tube nozzle 9 is generated by way of swirl-producing elements denoted therein by 20 in the gas outlet, which is denoted by 17′, thus ensuring appropriate fluidization of the solid. As indicated in FIG. 4, this gas supply 17/17′ can be configured, for example, as a circumferential annular gap, or can be provided with further outlet apertures over the circumference. A special advantage of this configuration consists in that recirculated dust-laden gas can be used here to generate flow.

If the vessel is now emptied, gas can be supplied in such a way that the wall friction in and around the emptying tube and at the vessel walls is decreased, with the result that the solid present locally there is loosened. In this way, the supplied gas accelerates the transfer of the solid into a downstream system part. Because of the gas supply, the volume cleared by the exchange of solids is refilled in the vessel. In the process, excess gas can be supplied, and this is of importance for avoiding a negative pressure gradient at the outlet aperture 9.

This negative pressure gradient would develop, for example, if the solid were to run out faster than the cleared volume is refilled with gas, with the result that gas could flow upward in the outlet aperture and in a direction opposite to arrow “g”, i.e. against the descending movement of solids, and this would lead to a distinct hindrance to the discharge of solids.

According to the invention, the discharge rate is increased by virtue of the gas excess.

Since the individual segments can be equipped with separate gas connections, the possibility also exists of admitting gas individually to the individual segments 8 and thus controlling the flow of solids in targeted manner. The segment-wise addition of gas therefore permits a best possible distribution of gas in the solid bulk material, thereby making it possible to achieve improved fluidization of even difficult products during the discharge operation.

Naturally, the described exemplary embodiment of the invention can be further modified in numerous respects without departing from the basic idea. Thus the invention is not restricted to providing only a central tubular member, but instead the cross-sectional shape of this member may also differ from the tubular shape, and also more than one such member may be provided parallel next to one another, along with further similar options.

### LIST OF REFERENCE NUMERALS

1 Sluice vessel

2 Central tube

3 Solid bulk material

4 Gas supply lines

5 Lateral inlet apertures for solids

6 Gas-supply unit

7 Gas-supply unit

8 Segments/annular chambers

9 Tube nozzles

10 Outer tube jacket

11 Inner tube jacket

12 Gas outlet

13 Supply of solids

14 Equalizing line

15 Equalizing line

16 Gas supply

17 Gas supply

18 Shutoff mechanism

19 Vessel bottom

20 Swirl-producing element

1. Apparatus (1) for receiving fine-grained to coarse-grained solids from a vessel and transferring them to a higher-pressure system by way of a shutoff mechanism, whereby the vessel is equipped with devices for supplying the solid and for supplying gases to raise the pressure in the vessel as well as with devices for pressure equalization during filling and emptying, whereby the vessel bottom is formed as a funnel for supplying the shutoff mechanism, wherein
at least one vertically aligned central tubular member (2) (central tube) open at the top and bottom as well as gas-supply devices (4, 7) for admitting gas to the vessel bottom (19) and/or the central tube (2) in order to generate a flow of solids in the central tube are provided inside the vessel (1′) above the shutoff mechanism (18) in the direction of gravity (g), and spaced apart from it.

2. Apparatus according to claim 1, wherein
the central tube (2) is of double-wall construction and has gas applied to it by at least one gas-supply line (4), whereby the tube wall (8) is provided with gas-outlet apertures (12).

3. Apparatus according to claim 2, wherein
the central tube (2) is equipped with outwardly directed and/or inwardly directed gas-outlet apertures.

4. Apparatus according to claim 1, wherein
the central tube (2) is equipped with inlet apertures (5), distributed over its length, for the solid.

5. Apparatus according to claim 1, wherein
not only the funnel-shaped vessel bottom (19) but also further regions of the vessel and/or outlet-tube nozzles (9) are equipped with gas-supply devices (6, 16, 17).

6. Apparatus according to claim 1, wherein
segments or annular chambers (8) are formed by partition walls in the double-walled central tube (2), whereby each annular chamber is equipped with at least one gas-supply line (4), whereby the solid-inlet apertures into the interior of the central tube are provided between the annular chambers (8), and whereby the diameter of the annular chambers (8) may be the same or different.

7. Apparatus according to claim 1, wherein
the walls of each annular chamber (8) are equipped with gas-outlet apertures (12) in the jacket region and/or end-face region.

8. Apparatus according to claim 1, wherein
at least some of the gas-outlet apertures in the vessel walls and/or in the central-tube walls and/or in the outlet-tube nozzle (9) are provided with elements (20) for guiding the gas flow, in order to form predefined flows, for example tangential flows.

9. Apparatus according to claim 1, wherein
the supply of solids is positioned in a manner offset from the center of the central tube, such that solids are prevented from falling into the central tube during the filling operation.

10. Apparatus according to claim 1, wherein
a protective/deflecting hood (20) is disposed above the central tube (2) in order to deflect the upwardly directed flow of solids during priming of the vessel and to prevent the tube from filling with solid during the filling operation.

11. Method for receiving fine-grained to coarse-grained solids from a vessel and transferring them to a higher-pressure system, whereby the vessel is equipped with devices for supplying the solid and for supplying gases to raise the pressure in the vessel as well as with devices for pressure equalization during filling and emptying, wherein
at least one vertically aligned central tubular member (central tube) is provided inside the vessel above the shutoff mechanism in the direction of gravity, at a distance from it, whereby the filling of the receiving vessel, which initially is under ambient pressure, with solid takes place in the annular space formed between the inside wall of the vessel and the outside wall of the central tube and a gas is injected in the region of the shutoff mechanism during the filling operation, whereby pressure equalization is achieved by way of a gas supply/removal controller, and subsequently, the vessel is brought up to the higher system pressure prevailing on the other side of the shutoff mechanism by supply of gas, whereby the gas is injected in such a way that an upwardly directed flow of solid is formed in the central tube.

12. Method according to claim 11, wherein
during transfer of the solid into the higher-pressure system by supply of gas by way of gas-supply apertures in the vessel walls and/or in the double-walled central tube and/or in the bottom, fluidization of the solid and/or conveyance of the solid toward the transfer sluice is established.

13. Method according to claim 11, wherein
nitrogen, carbon dioxide, recirculated flue gas, air, synthesis gas or mixtures may be used as the gas for conveyance, pressure equalization and fluidization, whereby these gases may also be dust-laden.

14. Method according to claim 11, wherein
a flow of solid in the vessel is established by means of flow-guiding lines in the region of the gas-outlet apertures, in order to facilitate transfer of the solid.

15. Method according to claim 11, wherein
the supplied gas flow rate is controlled in such a way that the pressure variation during the pressurization operation follows a well-defined time dependence, which preferably lies within the boundary cases, namely supplied mass flow perfectly constant and supplied operating volume flow perfectly constant (relative to the current operating parameters in the sluice vessel).
